(19) United States
(12) Patent Application Publication
(10) Pub. No.: US 2026/0276934 A1
(43) Pub. Date: Sep. 17, 2026

(54) OPTICAL SHUFFLE BOX

(71) Applicant: MELLANOX TECHNOLOGIES, LTD., Yokneam (IL)

(72) Inventors: Dima Denisenko, Afula (IL); Alex Kremenetsky, Kiryat Bialik (IL); Amit Oren, Ramat Hasharon (IL); Moti Cabessa, Ramat Gan (IL)

(21) Appl. No.: 19/080,215

(22) Filed: Mar. 14, 2025

(51) Int. Cl. G02B 6/44

(52) U.S. Cl. CPC G02B 6/44528

(57) ABSTRACT

An optical shuffle box connects each of a plurality of optical adapters with all of a plurality of computing resources that are connected to the shuffle box via a plurality of optical backplane connectors. The optical shuffle box comprises a plurality of optical backplane connectors; a front panel comprising a plurality of optical adapters; a plurality of fibers connecting the plurality of optical backplane connectors with the plurality of optical adapters; and wherein the optical shuffle box is detachably connectable with one or more optical I/O computing resources in part by the plurality of optical backplane connectors to optically connect each of the plurality of optical adapters of the front panel with each of the one or more optical I/O computing resources.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Links between computing resources and/or chips thereof are based on copper cables (short reach) or optical cables. In the optical cables, the data to be transferred between chips (or switches) is encoded/decoded from electrical to optical signal (and vice versa) and conveyed via an optical fiber. For optical connections, optical switches encompass computing resources to distribute data packets among a plurality of optical channels to multiple receivers. Historically, optical components have been provided separately from computing resources, and so the physical size of the combination of optical components and separate computing resources has been one of the limiting factors in data center designs. However, with the introduction of co-packaged optics (CPO) designs including optics and computing resources, the combined size of optics and computing resources is relatively small, and other physical devices have become larger contributors to size limitations in data center designs, including shuffle boxes for connecting fibers with optical switches. Therefore, there is a need in the art for compact shuffle box configurations that enable connection between many optical fibers with one or more optical switches.

### GENERAL DESCRIPTION

The physical size of optical connectors at an optical switch is increasingly becoming a limiting factor in data center design, as the size the optical switches themselves decrease. Moreover, some data center designs require additional adapters at the optical connectors to accommodate different connector types further exacerbating the spatial concerns of including the necessary connectors and adapters at optical switches. The size of these optical connectors (and adapters) becomes difficult to accommodate as the size of the optical switches decreases, such as a result of CPO switch designs that enable the packaging of multiple optical switches within a single tray. Traditional optical switches use optical transceivers in the front panel, while CPO switches do not have transceivers at the front panel and position the optical engines inside the box. CPO switch designs thereby reduce costs and power consumption as compared with traditional optical switch designs. However, there is a need to efficiently route many fibers from the center computing resource (e.g., chip) to the front panel of an optical I/O switch (e.g., a CPO switch) and for routing fibers to an external laser source. These fibers may comprise multiple fiber types (e.g., single mode fibers (SMF) for connection with the computing resources and polarization maintaining fibers (PMF) for connection with the external laser source small form factor pluggable (ELSFP) connections). The challenge is routing the fibers from the center chip to the front panel in a way that each connection point connects to the correct fibers. The chips have many fibers extending therefrom, and so collectively the shuffle box much accommodate over 1000 fibers without damaging them. This involves ensuring that each pair of transmitter and receiver fibers is connected to a dedicated chip. The optical shuffle box discussed herein manages the complex routing and ensures that fibers are correctly connected without mixing them up, thereby solving the meshing challenge.

An optical shuffle box as discussed herein is a “many-to-many” optical connector shuffle box having a front panel with a plurality of optical connectors (e.g., 8-12- or 16-fiber MPO/MTP connectors) that detachably connects with a plurality of optical I/O computing resources (e.g., CPO computing resources, such as CPO switchboards (e.g., 4 CPO switchboards)) using a plurality of optical backplane connectors rigidly secured within a back panel of the shuffle box (opposite the customer interface). The shuffle box provides the same design for different footprints. When the connection point connects to 8 fibers, 4 fibers are transmitters and 4 fibers are receivers. These shuffle boxes enclose the necessary connections for providing customer-accessible connection adapters to the optical I/O switchboards in a compact arrangement that addresses the foregoing spatial concerns of connectors at optical I/O switchboards, while also maintaining an ability to connect different optical shuffle box configurations relative to the optical I/O switchboards. These shuffle boxes addresses the complexity by handling the fiber matrix within a separate mechanical housing. Connectors of the housing is attachable to connectors of the optical I/O computing resources with a simple click, minimizing assembly errors, and the shuffle box housing can be secured to a tray of the optical I/O switch with guide pins and/or fasteners to mechanically secure the housing of the optical shuffle box with the optical I/O tray.

In the described shuffle box, the plurality of optical backplane connectors are arranged in a backplane array on the back panel. The shuffle box may comprise a plurality of “cassettes” each having a plurality of optical adapters accessible from the front panel of the shuffle box. Each cassette defines a cassette panel that forms a portion of the front panel of the shuffle box. Each optical adapter connector is configured for connection with a corresponding optical cable; for example, an optical adapter includes fibers that connect to each of a plurality of optical backplane connectors that connect with mating connectors on a plurality of optical I/O computing resources, such as optical I/O switchboards (or on fibers/cables that lead to the optical I/O switchboards). In some embodiments, each cassette also has an associated external laser source plug leading to the plurality of optical backplane connectors.

The shuffle box can be disconnected from the optical I/O computing resources, by physically removing the shuffle box, thereby detaching the optical backplane connectors and disconnecting mechanical fastening assemblies (e.g., screws, interference-fit connectors, and/or the like) securing the shuffle box with a housing of the switchboard(s). The size of the shuffle box can be scaled as needed, and the types of optical adapters can be changed (e.g., by replacing the shuffle box) as needed to offer the flexibility to be replaced to meet varying requirements. The replaceable shuffle box allows for fast assembly and direct integration in the system, enables the shuffle box to be tested separately, prevents human errors during assembly, and reduces the overall volume of the entire setup. This approach enables: testing each side independently before integration and customizing different planarization architectures and adapter types without altering the overall system design. The shuffle box configuration allows for customization of the front panel connectors. For example, customers can choose different types of connectors without redesigning the entire system, making it a flexible solution for various requirements. The use of an optical backplane connector enables the simple assembly and disassembly of the shuffle box from the system. The shuffle box comprises a plurality of cassettes (e.g., 18 cassettes), making manufacturing and testing more efficient and cost-effective. The shuffling process occurs at two levels: the first level takes place within the cassettes. The optical outputs from the cassettes are then shuffled again before connecting to the backplane optical connectors.

Certain embodiments are directed to an optical shuffle box comprising: a housing having a back panel and a front panel; a backplane array comprising m optical backplane connectors in the back panel of the housing; a front panel array comprising n connection points in the front panel of the housing, wherein the n connection points are optically connected with a plurality of optical backplane connectors of the m optical backplane connectors; wherein n is greater than m.

In certain embodiments, the backplane array comprises a plurality of optical backplane connectors subsets; the front panel array comprises a plurality of connection point subsets; and each connection point subset is connected with all of the optical backplane connectors subsets. In various embodiments, each of the plurality of connection point subsets define a column of connection points within the front panel of the housing; each of the plurality of optical backplane connectors subsets are arranged in rows in the back panel of the housing. In certain embodiments, the optical shuffle box further comprises an external laser source port array comprising a plurality of external laser source ports, wherein the plurality of external laser source ports are connected with the m connectors in the back panel. In various embodiments, the n connection points collectively define greater than 40% of the front panel of the housing. In certain embodiments, the optical shuffle box further comprises an external laser source port array comprising a plurality of external laser source ports located above the housing.

Various embodiments are directed to an optical shuffle box comprising: a plurality of optical backplane connectors; a front panel comprising a plurality of optical adapters; a plurality of fibers connecting the plurality of optical backplane connectors with the plurality of optical adapters; and wherein the optical shuffle box is detachably connectable with one or more optical I/O computing resources in part by the plurality of optical backplane connectors to optically connect each of the plurality of optical adapters of the front panel with each of the one or more optical I/O computing resources.

In certain embodiments, the plurality of optical adapters are MPO adapters. In various embodiments, the plurality of fibers comprises one or more fiber groups, wherein each of the one or more fiber groups connect each optical adapter of the plurality of optical adapters with all of the plurality of optical backplane connectors. In certain embodiments, the optical shuffle box is one of a plurality of optical shuffle boxes each having a configuration, and wherein the optical shuffle box is detachably connectable with the one or more computing resources to enable replacement of the optical shuffle box with a second optical shuffle box of the plurality of optical shuffle boxes having a different configuration. In various embodiments, the one or more optical I/O computing resources comprises a plurality of optical I/O computing resources; the plurality of optical adapters are arranged in columns of optical adapters of the plurality of optical adapters; each column of optical adapters is connected with each of the plurality of optical I/O computing resources through a corresponding subset of optical backplane connectors of the plurality of optical backplane connectors to provide vertical shuffling of signals from the plurality of optical I/O computing resources to the optical adapters within each column of optical adapters; and each of the plurality of optical I/O computing resources is connected with each of the columns of optical adapters to provide horizontal shuffling of signals from the plurality of optical I/O computing resources to each column of optical adapters.

In certain embodiments, the optical shuffle box further comprises a plurality of cassettes occupying the front panel, wherein: each of the plurality of cassettes is associated with a corresponding subset of optical backplane connectors of the plurality of optical backplane connectors, and each of the plurality of cassettes comprises a corresponding subset of optical adapters of the plurality of optical adapters, wherein the corresponding subset of optical adapters is connected with the corresponding subset of optical backplane connectors.

In various embodiments, the one or more optical I/O computing resources comprises a plurality of optical I/O computing resources; and the corresponding subset of optical backplane connectors associated with each of the plurality of cassettes comprises at least one optical backplane connector connected with each of the plurality of optical I/O computing resources. In certain embodiments, the plurality of cassettes collectively define a cassette panel within the front panel, and wherein the plurality of adapters collectively define at least 50% of the cassette panel. In various embodiments, the optical shuffle box further comprises a plurality of external light source connectors connected with the plurality of optical backplane connectors.

Certain embodiments are directed to a method comprising selecting a first optical shuffle box of a plurality of optical shuffle boxes having different front panel configurations; wherein each of the plurality of optical shuffle boxes comprise: a plurality of optical backplane connectors; a front panel comprising a plurality of optical adapters; a plurality of fibers connecting the plurality of optical backplane connectors with the plurality of optical adapters; and connecting the first optical shuffle box with one or more optical I/O computing resources at least in part by connecting the plurality of optical backplane connectors with the one or more optical I/O computing resources.

In certain embodiments, the method further comprises disconnecting the first optical shuffle box from the one or more optical I/O computing resources at least in part by disconnecting the plurality of optical backplane connectors from the one or more optical I/O computing resources; selecting a second optical shuffle box from the plurality of optical shuffle boxes, wherein a front panel of the second optical shuffle box has a different configuration than the first optical shuffle box; and connecting the second optical shuffle box with the one or more optical I/O computing resources at least in part by connecting the plurality of optical backplane connectors of the second optical shuffle box with the one or more optical I/O computing resources.

In various embodiments, connecting the first optical shuffle box with the one or more optical I/O computing resources comprises sliding one or more alignment pins into a housing of the first optical shuffle box. In certain embodiments, the one or more alignment pins are on a tray containing the one or more optical I/O computing resources; and sliding the one or more alignment pins into the housing of the first optical shuffle box further causes the optical backplane connectors to connect with the one or more optical I/O computing resources.

### BRIEF DESCRIPTION OF THE SEVERAL VIEWS OF THE DRAWINGS

For a better understanding of embodiments of the disclosure and to show how the same may be carried into effect, reference will now be made, purely by way of example, to the accompanying drawings in which like numerals designate corresponding elements or sections throughout. In the accompanying drawings:

FIG. 1 shows a front perspective view of a fiber shuffle box according to an embodiment;

FIG. 2 shows a rear perspective view of the fiber shuffle box of FIG. 1;

FIG. 3 shows a front view of the fiber shuffle box of FIG. 1;

FIG. 4 shows a rear view of the fiber shuffle box of FIG. 2;

FIG. 5 schematically illustrates the connection between a cassette of a shuffle box with computing resources of a CPO switch according to an embodiment;

FIG. 6A schematically illustrates the connections between connection points and connectors within a cassette of a shuffle box according to an embodiment;

FIG. 6B illustrates a cassette panel according to an embodiment;

FIG. 6C schematically illustrates fiber connections of a cassette according to an embodiment;

FIG. 6D illustrates an example cassette and included fiber connections according to an embodiment;

FIG. 7 shows a front perspective view of the fiber shuffle box of FIG. 1, with an ELSFP substrate secured thereto;

FIG. 8 shows the shuffle box of FIG. 7 aligned for installation into a switch housing according to an embodiment;

FIG. 9 shows a rear view of the shuffle box of FIG. 7 aligned for installation into the switch housing according to an embodiment;

FIG. 10 shows a side cutaway view of the shuffle box installed into the switch housing according to an embodiment;

FIG. 11 shows an assembled CPO switch including the shuffle box according to an embodiment;

FIG. 12 illustrates an example computer system that may include electrical components, according to at least one embodiment;

FIG. 13 provides a block diagram that schematically illustrates a computing system that may include one or more electrical components of various embodiments;

FIG. 14 illustrates an example computing environment that may include electrical components, in accordance with at least one embodiment;

FIG. 15 illustrates an example network switch according to at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

As computing resources and optical switch assemblies become more compact (e.g., due to CPO technologies), optical switch trays enable a higher density of optical connections. However, different customers have different needs for optical connections from a switch tray, leading to a need for flexibility in providing different connectivity layouts for optical switch trays.

As used herein, the term “optical cable” refers to a cable consisting of one or more optical fibers that are bundled together. The optical cable may provide the optic fibers in any geometric arrangement, including as a ribbon (e.g., with a plurality of optic fibers arranged side-by-side in one or more rows), as a grouped bundle that defines an at least substantially circular cross-section of the optical cable. In some embodiments, the individual fibers within a bundle may be individually sheathed (such that the sheaths of individual fibers are not connected with one another), and the plurality of sheathed fibers may be provided within a single jacket. In some embodiments, the jacket and sheath may be integrated, such as for a ribbon cable in which the integrated jacket and sheath serve to sheath individual fibers and to maintain a desired flat arrangement of the fibers relative to one another. The jacket and sheaths can be flexible, so that the resulting optical cable is flexible. As an example, the jacket and sheaths may be flexible polymers. However, it should be understood that other jacket and sheath configurations may be utilized.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light. In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally have a smaller diameter than the optical fibers. As such, a “world-to-chip” interface problem often arises in SiP technologies where coupling of light between Si wire waveguides and optical fibers, and vice versa, is generally inefficient. “Co-packaging” may refer to the close integration of different electrical and/or optoelectronic chips in the same package.

In some embodiments, the shuffle box includes at least three connector types and at least two fiber types. One connector type connects to at least one of each of the other two connector types using different fiber types for each connection. Thus, a first connector type comprises at least two different fiber types (e.g., polarization maintaining fibers (PMFs) and single mode fibers (SMFs)). A first fiber type connects to a second connector type, and a second fiber type connects to a third connector type. SMFs comprises a single core surrounded by a cladding layer. PMF fibers comprise a single core having two stress rods on opposite sides of the core. The core and stress rods are surrounded by a cladding layer. As the terms are used herein, it should be understood that SMFs do not contain stress rods, while PMFs contain stress rods.

For a SiP-based shuffle box as a part of a CPO switch (or other optical I/O switch), the shuffle box accommodates over 1000 fibers (including both transmission and receiving fibers) without damaging them in order to provide optimal connections to multiple computing resources. Moreover, the shuffle box accommodates different types of fibers, such as SMF fibers for connection to the computing resources and PMF fibers for connection to external laser sources. The shuffle box is replaceable relative to an optical I/O switch, without damaging the included fibers.

### Shuffle Box

A shuffle box as discussed herein is connectable with computing resources of an optical I/O switch (e.g., CPO computing resources operating as a CPO switchboard of a CPO switch) to connect an array of external connectors with multiple computing resources with both transmission and receiving fibers. The shuffle box includes optical I/O connectors that connect with computing resources of the optical I/O switch, and the shuffle box acts as an adapter to connect a select external connector type (or multiple external connector types) with the computing resources of the optical I/O switch. The shuffle box also accommodates multiple fiber types, including SMF and PMF fibers (more specifically, including transmission SMF, receiving SMF, and PMF fibers) for providing necessary connection types within the shuffle box. The shuffle box is replaceable, and can be detached from the optical I/O switch and replaced with an alternative configuration shuffle box, for example, with different external connector types. Moreover, the same optical I/O switch assembly can be used with different shuffle box configurations as different customers may desire different connection options.

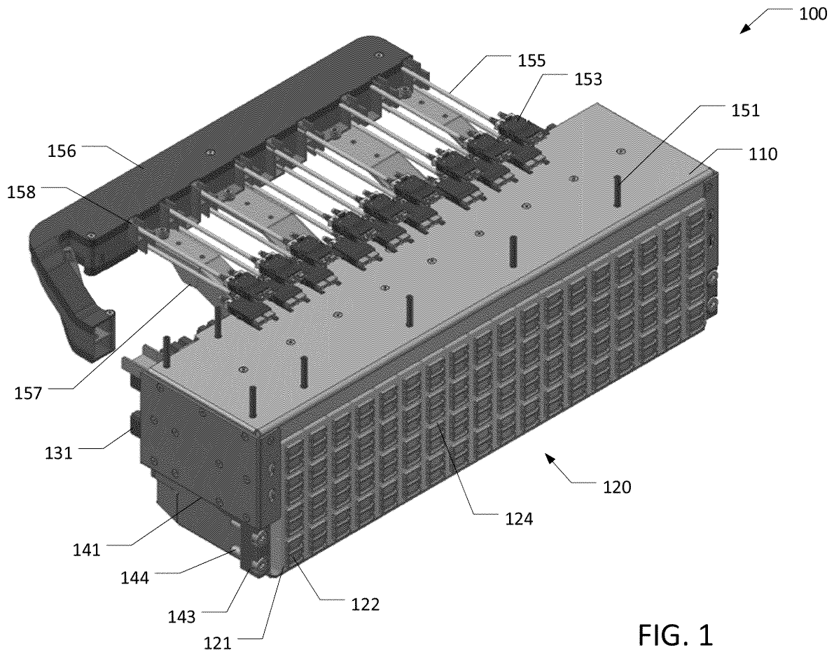

FIGS. 1-4 show an example optical shuffle box 100 according to one embodiment. The shuffle box 100 comprises a housing 110 defining at least a front panel 120, a back panel 130, and a top surface extending between the front panel 120 and the back panel 130. The housing 110 encloses a plurality of components (e.g., optical cables, optical connectors, and/or the like) connecting connectors of the front panel 120 with connectors of the back panel 130. The housing 110 further comprises one or more installation components to ensure that connectors of the back panel 130 are connected appropriately to connectors within an optical I/O tray. The installation components may comprise one or more horizontal staging ledges 141 (e.g., on opposite sides of the shuffle box housing 110) to support the shuffle box 100 on a horizontal staging support 241 within a tray 200 while the shuffle box 100 is being slid into place within the tray 200. The installation components may further comprise alignment holes 142 configured to accept an alignment pin 242 of a tray 200. In some embodiments, the housing 110 comprises a plurality of alignment holes 142 (e.g., on opposite sides of the back panel 130) to ensure that the shuffle box 100 is slid into the optical I/O tray 200 while maintaining a desired alignment of the shuffle box 100 relative to the tray 200. The installation components may additionally comprise one or more fastener brackets 143 configured to be secured to the tray 200 with fasteners 144 (e.g., screws).

On a top surface of the housing 110, the shuffle box 100 may comprise one or more supports for additional substrates. In the illustrated embodiment, the one or more supports comprise stand-offs 151 to support a substrate 152 for external laser small form factor pluggable (ELSFP) connectors 153 and corresponding housings 154 located above the housing 110. Optical cables 155 for the ELSFP connectors 153 can be routed out of the housing 110 through the back panel 130, through a ELSFP cable housing 156 (which may be secured to the housing 110 by a bracket 157), and out ELSFP apertures 158 aligned with the ELSFP connectors 153. As a result, the ELSFP connectors 153 (and their respective housings 154) are spaced above the housing 110 of the shuffle box 100, such ELSFP sources can be plugged into the ELSFP connectors through a tray front surface 220.

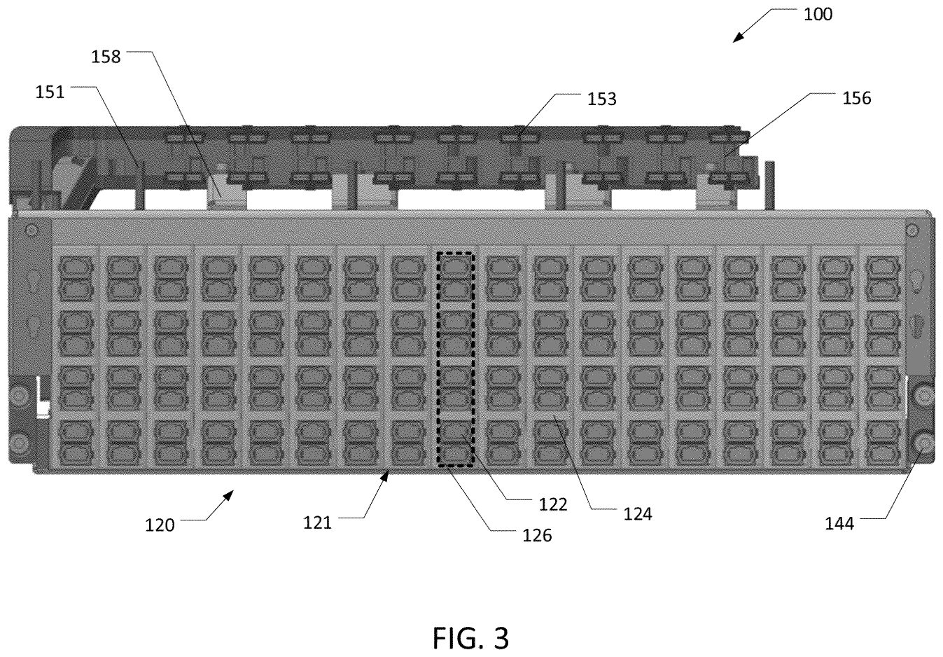

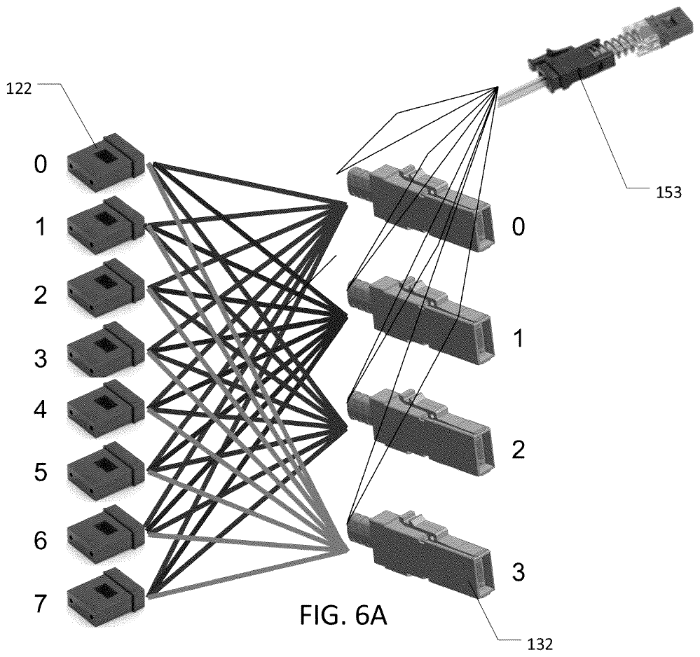

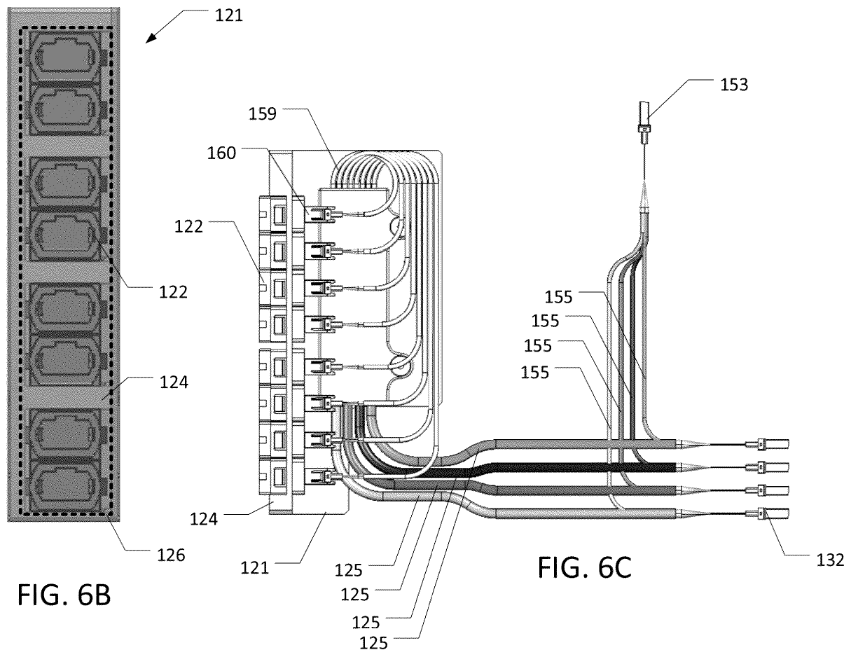

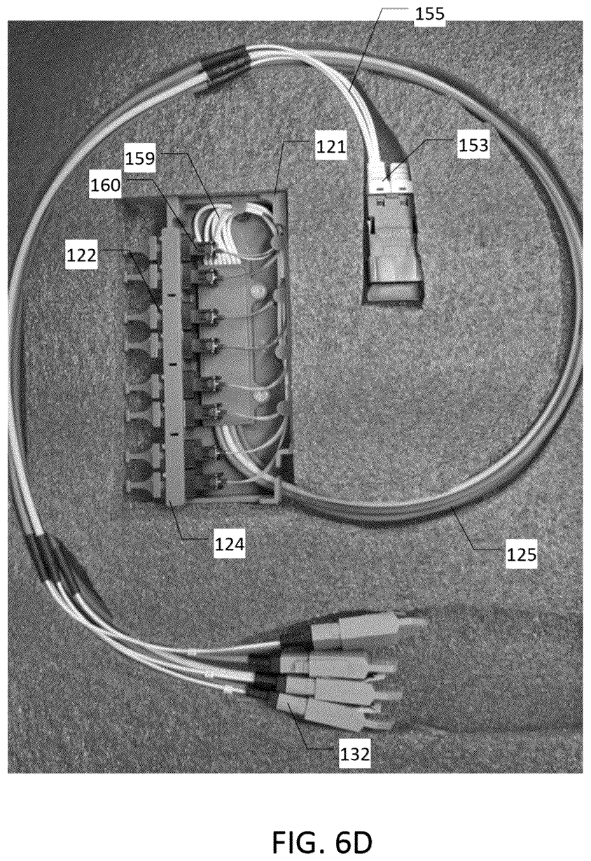

With reference to FIGS. 1 and 3, the shuffle box 100 comprises a plurality of cassettes 121 each having a cassette panel 124 (e.g., a front surface of the cassette, shown in close-up in FIG. 6B) that defines a portion of the front panel 120. The connection points 122 of all of the cassettes 121 collectively define a connection point array in the front panel 120. As shown, those connection points 122 are defined as female connectors in the illustrated embodiments. Each cassette 121 comprises a connection points subset (outlined and labeled as 126) within the respective cassette panel 124, including a subset of the plurality of connection points 122 of the front panel. In the illustrated embodiment, a connection points subset is 8 connection points (arranged vertically in the illustrated embodiment). In other embodiments, the connection points 122 need not be defined in separate cassettes 121, and they can be defined within an at least substantially continuous front panel 120 of the shuffle box 100. In certain embodiments, the connection points 122 can be defined in connection point subsets each including a subset of the total number of connection points of the front panel without separating the connection point subsets into separate cassettes.

The front panel 120 is compact and defined by the cassette panels 124 of all of the cassettes 121, the connection points 122, and a portion of the housing 110 that it is at least substantially planar with the cassette panels 124 of the cassettes 121. In the illustrated embodiment of FIG. 3, the connection points define greater than 30% of the total area of the front panel 120. More specifically, the connection points of FIG. 3 define greater than 35% of the total area of the front panel 120. Even more specifically, the connection points define greater than 40% of the total area of the front panel 120. In certain embodiments, the connection points may be smaller or larger relative to the overall size of the cassette panels 124 and front panel 120 of the shuffle box 100.

In the illustrated embodiment, the front panel of the shuffle box comprises 18 cassettes 121 with 8 connection points each (e.g., arranged in individual columns for each connection point) and 18 external laser source ports, for a total of 144 connection points collectively defining a front panel array on the front panel 120 of the shuffle box 100. The connection points are multi-fiber push on (MPO) ports. However shuffle boxes according to the present disclosure may include more or fewer connection points and may include different connection point types, such as LC (Lucent connectors), FC (Ferrule connectors), MMC (Multi-fiber connectors), and/or SN connector (by Senko Advance Components). In some embodiments, the front panel of a shuffle box may comprise multiple different connection point types.

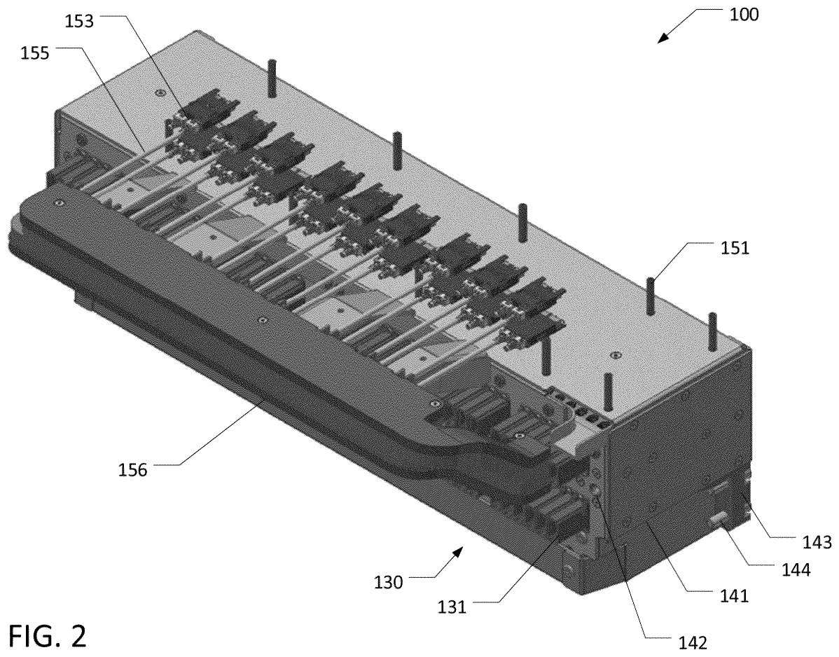

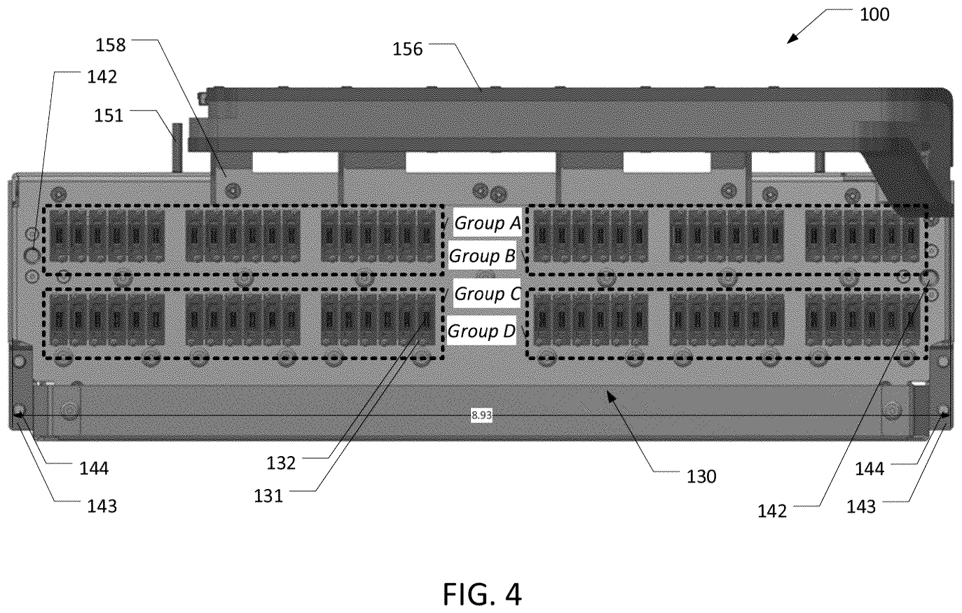

Each of the connection points 122 on the front panel 120 are connected with multiple connectors on a back panel by a plurality of optical fibers. When the shuffle box 100 is provided as a part of an optical I/O switch, each connection point 122 is connected with a plurality of computing resources (e.g., ASICs) of the optical I/O switch by optical fibers that extend from each connection point 122 to a plurality of optical backplane connectors 132 arranged in a backplane array on a back panel 130 of the shuffle box 100, as shown in FIGS. 2 and 4.

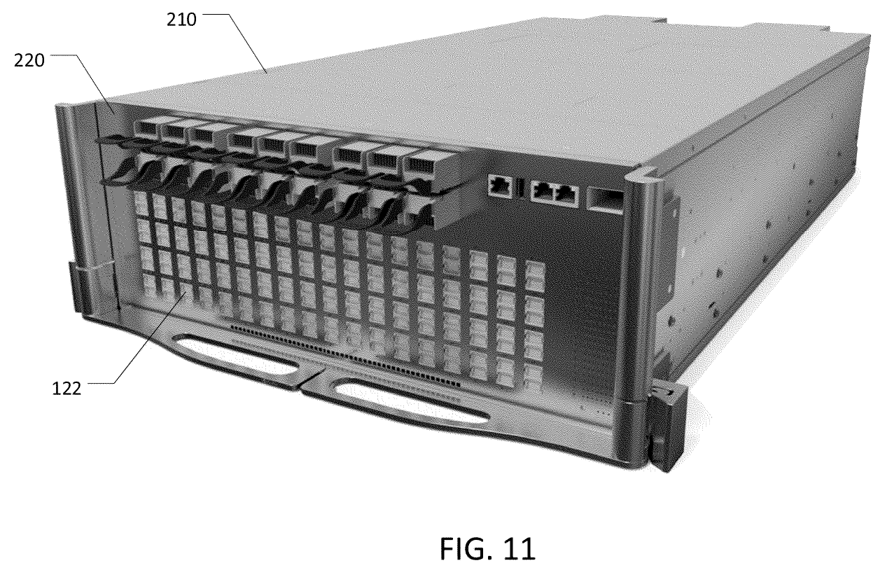

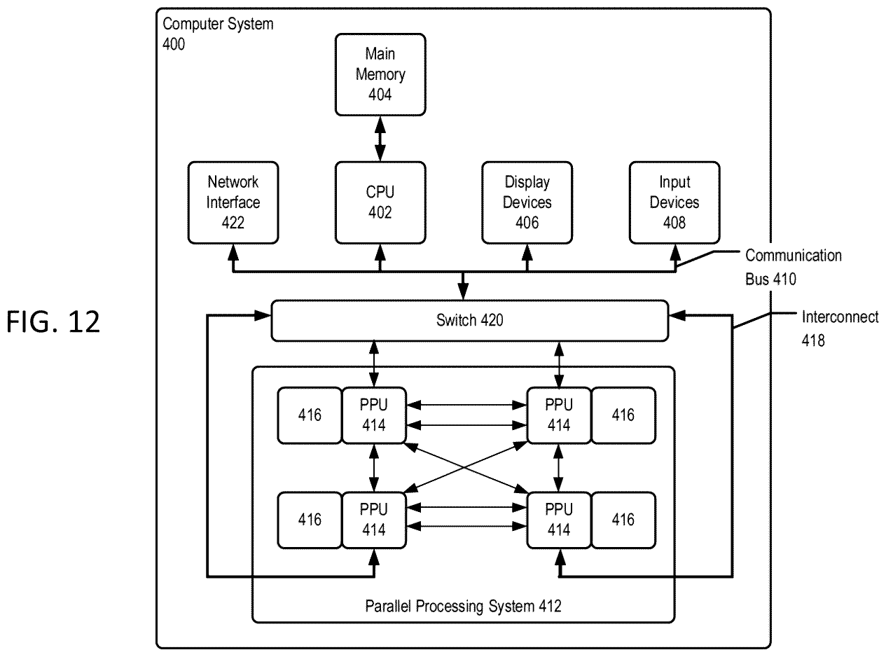

As shown specifically in FIG. 4 (and in more detail in FIGS. 11-12), the optical backplane connectors 132 are positioned within connector housings 131 that serve to guide the optical backplane connectors 132 into connection with mating connectors 232 as the shuffle box 100 is slid into position in the tray 200 of an optical I/O switch.

The optical backplane connectors 132 (and their respective housings 131) occupy a substantial amount of space on the back panel 130. In some embodiments, the optical backplane connectors 132 and their respective housings 131 collectively occupy greater than 25% of the total area of the back panel 130. More specifically, the optical backplane connectors 132 and their respective housings 131 collectively occupy greater than 30% of the total area of the back panel 130.

In the illustrated embodiments, the optical backplane connectors 132 are MXC connectors that are provide to connect with mating connectors 232 of the tray 200 that are connected to computing resources of the optical I/O switch. However, other optical backplane connector types may be used. Each of the optical backplane connectors 132 are connected to a plurality of connection points 122 on the front panel 120 by a plurality of optical fibers. Because each optical backplane connector 132 connects with a mating connector on the tray 200 that connects with a single computing resource, optical fibers in the shuffle box 100 serves to connect each of the connection points 122 with all of the computing resources of the optical I/O switch through the plurality of optical backplane connectors 132 on the back panel 130. Each optical backplane connector 132 in the back panel 130 may extend through an aperture configured to accommodate a single optical backplane connector 132 (and housing 131). In other embodiments, the optical backplane connectors 132 may be arranged into subsets of connectors that are secured relative to one another in a cassette/carriage/harness/etc. and the apertures in the back panel 130 may be configured to accommodate all connectors in a single subset that are connected to one another by a cassette/carriage/harness/etc.

As reflected in FIG. 4, the optical backplane connectors 132 of the back panel 130 are arranged into a plurality of groups (e.g., Group A, Group B, Group C, and Group D in the illustrated embodiment). Each group corresponds to a particular computing resource, such that all of the optical backplane connectors 132 in a particular group connect to a single computing resource. The groups of connectors are spatially separated from one another to accommodate the positioning of the computing resources within a tray of an optical I/O switch. It should be understood that the illustrated spacing of groups is a non-limiting example, and other spacing can be provided, as necessitated by the positioning of the computing resources of an optical I/O switch.

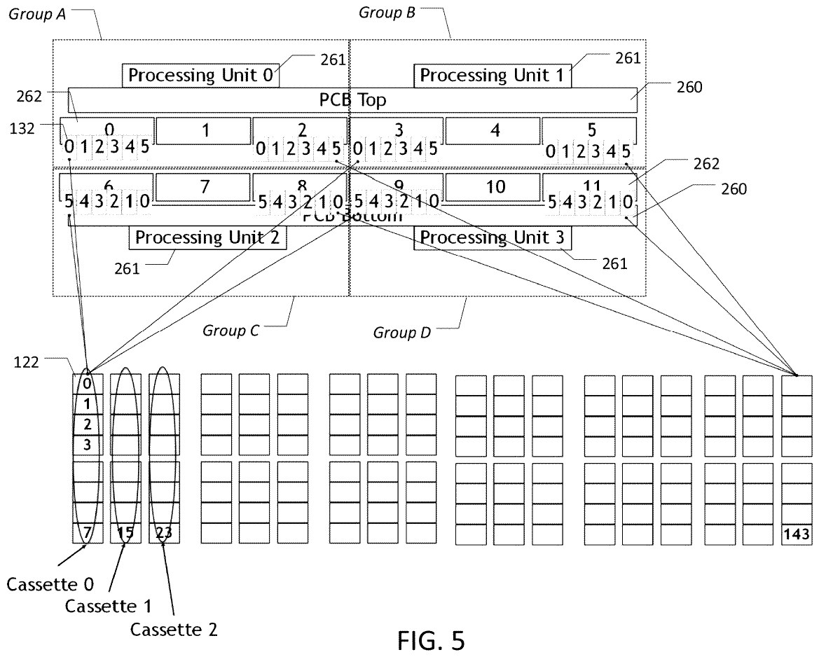

As mentioned, the plurality of connection points 122 are connected to groups of optical backplane connectors 132 by a plurality of optical fibers. Specifically, each of the plurality of connection points 122 are connected with a plurality of optical backplane connectors 132, and by extension, each of the plurality of optical backplane connectors 132 are connected with a plurality of connection points 122 by the plurality of optical fibers. The shuffle box thereby provides “shuffling” of connections between the connection points 122 and the optical backplane connectors 132. FIGS. 5-6 schematically illustrate the shuffling of connections between the optical backplane connectors 132 and connection points 122. As shown in FIG. 5, all of the connection points 122 in each cassette 121 are connected to one optical backplane connector 132 that is in communication with each computing resource 261. In other words, all of the connection points 122 in each cassette 121 are connected to one optical backplane connector 132 in each of the plurality of connector groups (e.g., Groups A-D). As discussed herein, all of the optical backplane connectors 132 in each connector group are connected with a common computing resource 261, for example, using optical fibers that pass through trays 211 mounted on the same substrate 212 as the computing resources 261 As shown, the optical I/O switch may comprise multiple substrates 212 each supporting multiple computing resources 261, each with multiple corresponding trays 211. More specifically, an optical I/O switch may comprise 4 computing resources 261, each with 3 trays 211, and each tray having 6 mating connectors that connect with corresponding optical backplane connectors 132. However, it should be understood that one or more connection points may not connect with one or more optical backplane connectors 132.

FIG. 6A provides further granularity of the shuffling among the plurality of connection points 122 of a single cassette 121 with the plurality of optical backplane connectors 132. As shown, each p connection point ort 122 of a cassette 121 (shown as a multi-fiber connector) is within a cassette panel (shown in close-up in FIG. 6B) connected with all of the optical backplane connectors 132 for the cassette 121. For example, each connection point 122 is connected to every optical backplane connector 132 of the cassette 121 by a plurality of optical fibers (e.g., 2 optical fibers in a simplex regime that collectively defines a lane including one fiber for transmission and one fiber for receipt).

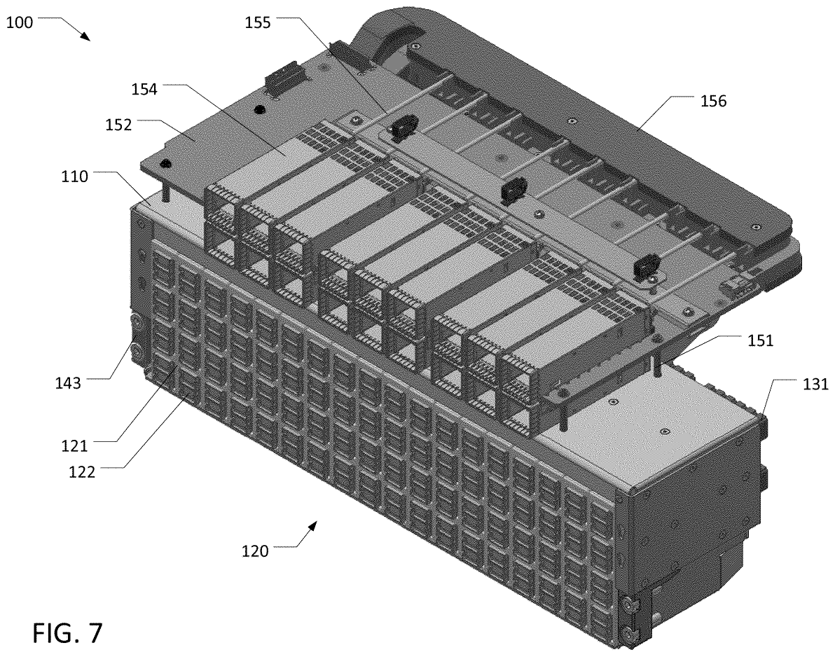

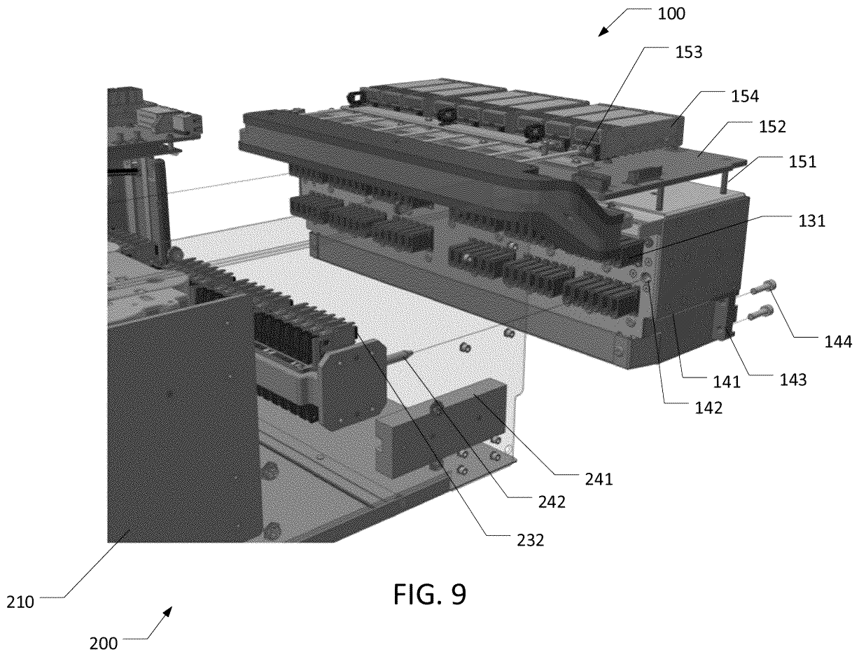

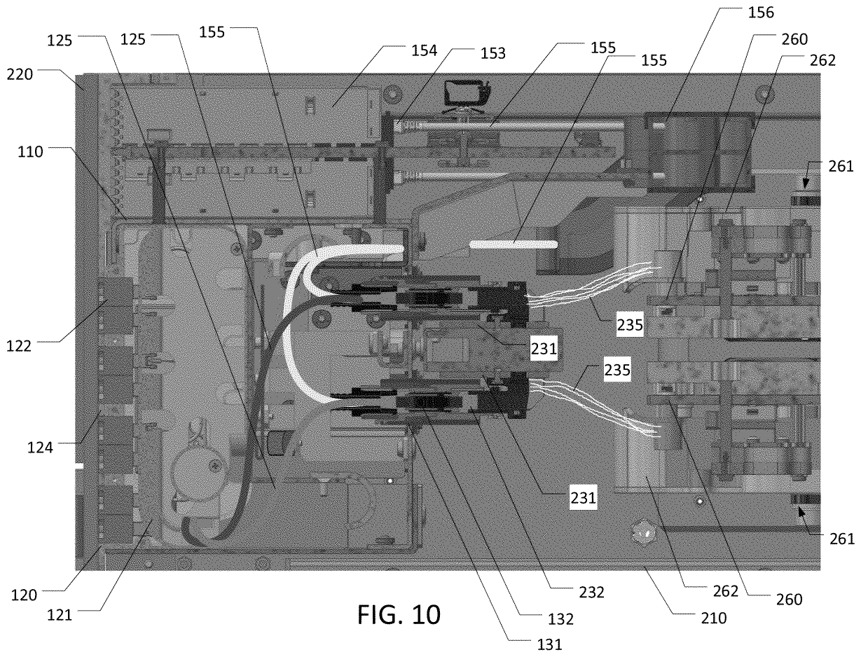

FIGS. 6C and 6D illustrate the connections between the connection points 122 of a cassette 121 and the optical backplane connectors 132 and ELSFP connector 153. As shown, optical fibers may be contained in one or more optical cables (e.g., optical cables 125, 159 as shown in FIG. 10) and may connect to the connection points 122 using at least one connector 160. Moreover, all of the plurality of optical backplane connectors 132 are connected with one ELSFP connector 153 (as shown in FIGS. 1, 2, and 7-10, an optical cable 155 extends from each ELSFP connector 153 and into the shuffle box 100 where it is connected with the optical backplane connectors 132.

In practice, shuffling among connection points 122 of a single cassette 121 provides a first layer of shuffling of signals (which may be referred to as vertical shuffling, with reference to the connection points being arranged in a vertical column within a cassette), and shuffling among optical backplane connectors 132 and their corresponding cassettes 121 provides a second layer of shuffling of signals (referred to as horizontal shuffling, to reference shuffling among optical I/O computing resources, at least some of which may be arranged horizontally adjacent to one another).

### CPO Switch Tray

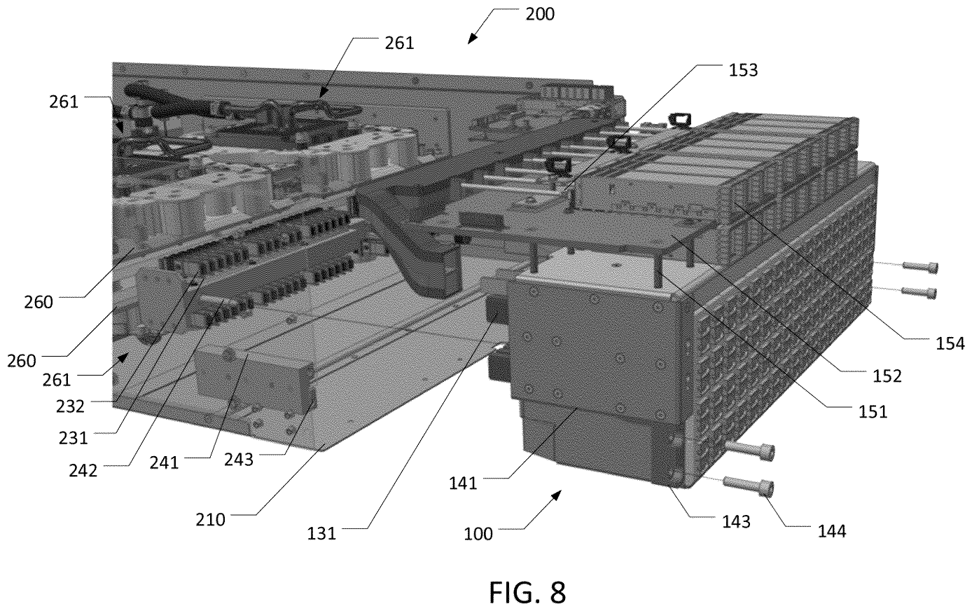

FIGS. 8-10 illustrate a CPO switch comprising a shuffle box 100 assembled with a switch tray 200, in various states of assembly. It should be understood that the CPO switch shown in FIGS. 8-10 is just one example of an optical I/O switch according to certain embodiments.

The switch tray 200 comprises a plurality of computing resources 261 mounted on substrates 260. In the illustrated embodiment, the plurality of computing resources 261 comprise a first plurality of computing resources mounted on a first substrate 260 and a second plurality of computing resources 261 mounted on a second substrate 260. The first plurality of computing resources 261 may be mounted on a top side of the first substrate 260 and the second plurality of computing resources 261 may be mounted on a bottom side of the second substrate 260. A plurality of optical fibers (which may be bundled in cables 235) are connected with the computing resources 261. The optical fibers are routed through trays 262 mounted on the substrates 260 and to mating connectors 232 mounted on connector substrates 231. The mating connectors 232 connect with optical backplane connectors 132 of the shuffle box 100 such that the optical backplane connectors 132 are connected with the computing resources 161.

The switch tray 200 houses the above-mentioned components within a tray housing 210. The tray housing 210 comprises one or more mating installation components that interact with the support components of the shuffle box 100. The support components may comprise one or more horizontal staging supports 241 that supports the weight of the shuffle box 100 when the horizontal staging ledges 141 of the shuffle box are resting on the staging supports 241 of the switch tray 200 while the shuffle box 100 is being slid into place within the switch tray 200. A front surface of the horizontal staging supports 241 comprises one or more threaded holes 243 for securing fasteners 144 extending through the fastener brackets 143 of the shuffle box 100 to secure the shuffle box within the switch tray 200. Moreover, the support components may additionally comprise one or more alignment pins 242 that mate with alignment holes 142 (e.g., on opposite sides of the back panel 130) to ensure that the shuffle box 100 is slid into the switch tray 200 while maintaining a desired alignment of the shuffle box 100 relative to the switch tray 200.

FIG. 10 shows a side cutaway view of a shuffle box 100 installed in a switch tray 200. When installed, the optical backplane connectors 132 snap together with the mating connectors 232. The resulting CPO switch connects the connection points 122 with computing resources 261 through optical fibers in cables 125 and 235. Moreover, ELSFP connectors 153 are in communication with computing resources 261 through optical fibers in cables 155 and 235. Both cables 155 and 125 connect with optical backplane connectors 132 within shuffle box 100.

As shown in FIGS. 10-11, the shuffle box 100 is enclosed within the CPO switch tray 200, such that a tray front surface 220 sheaths the shuffle box front panel 120. It should be understood that the shuffle box 100 may be enclosed within other types of optical I/O switch trays in a similar manner.

### Method of Interchanging a Shuffle Box

As discussed above, the shuffle box 100 is connectable with computing resources 261 of an optical I/O switch by connecting the optical backplane connectors 132 with mating connectors 232 of the optical I/O switch. The shuffle box 100 may be detached by reversing the connection process, by decoupling the optical backplane connectors 132 of the shuffle box 100 from the mating connectors 232. Accordingly, different shuffle box configurations may be selected for attachment to the computing resources 261 of the optical I/O switch.

To assemble an optical I/O switch, such as a CPO swtich, a shuffle box 100 is selected. The shuffle box may be selected based at least in part on a desired configuration of the shuffle box 100. Different shuffle box options may provide different connection point 122 configurations (e.g., different connection point styles, different connection point quantities, different connection point placements, and/or the like) and/or different shuffle configurations (e.g., the positioning of each connection point 122 connected with certain connections of the computing resources 261 may differ—for example, the connectivity of port 0 in FIG. 5 may be repositioned from the top left corner in one shuffle box 100 to the bottom right corner in a second shuffle box 100).

Once a shuffle box 100 is selected, it is connected with the computing resources 261 by sliding the shuffle box 100 along the alignment pins 242 and horizontal staging supports 241 until the optical backplane connectors 132 connect with the mating connectors 232 (e.g., by snapping into connection). Fasteners 144 are then connected to secure the shuffle box 100 to the tray housing 210. A tray front surface 220 may then be attached to enclose the shuffle box 100 within the CPO switch tray 200.

The selected shuffle box 100 can be replaced with another shuffle box having different characteristics. A second shuffle box 100 (e.g., having a different connection point configuration from the originally-connected shuffle box 100) is selected. The originally-selected shuffle box is then uninstalled, by first removing the tray front surface 220 and then removing the fasteners 144 to provide access to the installed original shuffle box 100. The optical backplane connectors 132 are decoupled from the mating connectors 232, and the shuffle box is slid along the alignment pins 242 and horizontal staging supports 241 until the originally selected shuffle box is cleared of the tray housing 210.

Then, the second shuffle box 100 is installed by sliding the second shuffle box 100 along the alignment pins 242 and horizontal staging supports 241 until the optical backplane connectors 132 connect with the mating connectors 232 (e.g., by snapping into connection). The fasteners 144 are then reinstalled to secure the second shuffle box 100 to the tray housing 210. A tray front surface 220 may then be attached to enclose the shuffle box 100 within the CPO switch tray 200. The tray front surface 220 installed for the second shuffle box 100 may have a different configuration (e.g., if the connection points 122 have a different size, quantity and/or placement) as compared to the tray front surface 220 installed for the originally installed shuffle box 100.

### Example Systems Including Shuffle Boxes

In various embodiments, shuffle boxes 100 are incorporated into various systems. For example, various shuffle boxes 100 may be incorporated into datacenters, CPO switches, other optical I/O switches, processing units, ICs, systems on and/or including PCBs, optical interconnects, and/or the like. Some example systems that may include shuffle boxes 100 of various embodiments are now described.

FIG. 12 illustrates a computer system 400, according to at least one embodiment. In at least one embodiment, computer system 400 is configured to implement various processes and methods described throughout this disclosure.

In at least one embodiment, computer system 400 comprises, without limitation, at least one central processing unit (“CPU”) 402 that is connected to a communication bus 410 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 400 includes, without limitation, a main memory 404 and control logic (e.g., implemented as hardware, software, or a combination thereof) and data are stored in main memory 404 which may take form of random access memory (“RAM”). In at least one embodiment, a network interface subsystem (“network interface”) 422 provides an interface to other computing devices and networks for receiving data from and transmitting data to other systems from computer system 400.

In at least one embodiment, computer system 400, in at least one embodiment, includes, without limitation, input devices 408, parallel processing system 412, and display devices 406 which can be implemented using a conventional cathode ray tube (“CRT”), liquid crystal display (“LCD”), light emitting diode (“LED”), plasma display, or other suitable display technologies. In at least one embodiment, user input is received from input devices 408 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 404 and/or secondary storage. Computer programs, if executed by one or more processors, enable system 400 to perform various functions in accordance with at least one embodiment. memory 404, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 402; parallel processing system 412; an integrated circuit capable of at least a portion of capabilities of both CPU 402; parallel processing system 412; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 400 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 412 includes, without limitation, a plurality of parallel processing units (“PPUs”) 414 and associated memories 416. In at least one embodiment, PPUs 414 are connected to a host processor or other peripheral devices via an interconnect 418 and a switch 420 or multiplexer. In at least one embodiment, parallel processing system 412 distributes computational tasks across PPUs 414 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 414, although such shared memory may incur performance penalties relative to use of local memory and registers resident to a PPU 414. In at least one embodiment, operation of PPUs 414 is synchronized through use of a command such as_syncthreads( ), wherein all threads in a block (e.g., executed across multiple PPUs 414) to reach a certain point of execution of code before proceeding.

The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

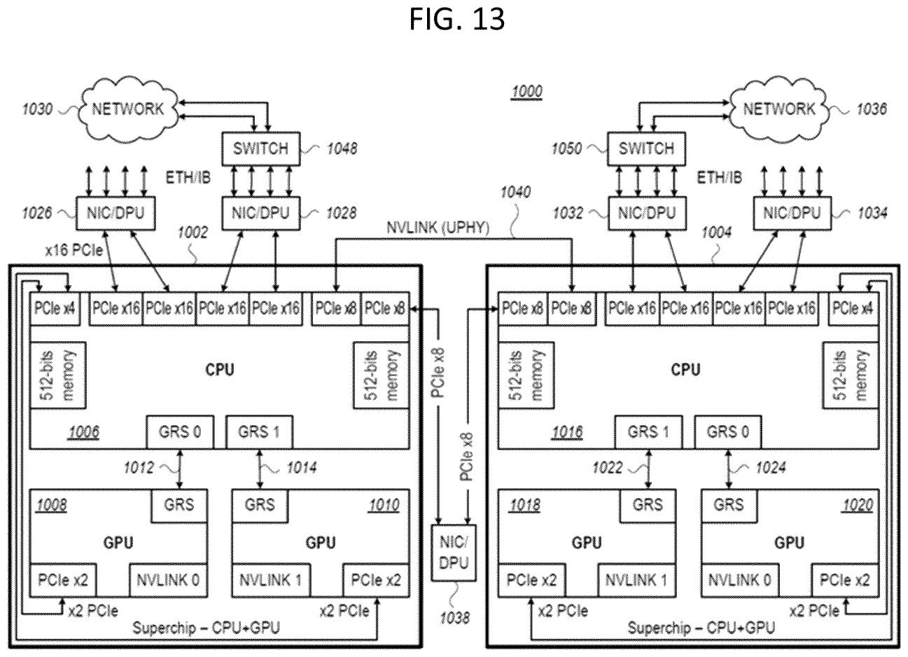

FIG. 13 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs, data processing units (DPUs), quantum processing units (QPUs), a plurality of parallel processing units (PPUs), and application-specific integrated circuits (ASICs). QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with..

FIG. 13 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 13, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

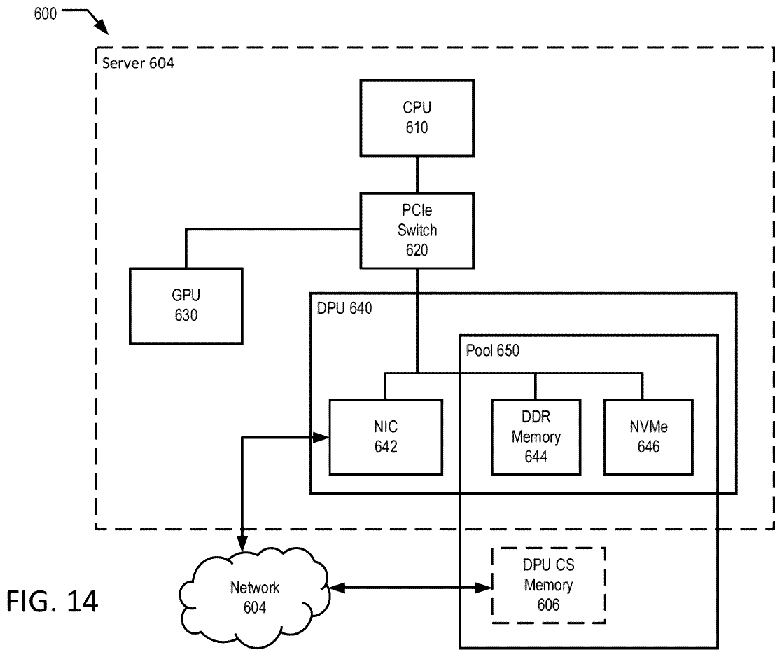

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 14, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 13 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034, and 1038, and/or any of switches 1048 and 1050, may include electrical components in accordance with various embodiments.

FIG. 14 illustrates an example computing environment 600 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 600 may include a server 602 which may be used to perform HPC workloads, such as AI training or machine learning model training. In an embodiment, the server 602 may be an application instance or a compute node. The server 602 may include a CPU 610 associated with a switch 620, such as a peripheral component interconnect express (PCIe) switch, which may control at least some data transmission over communication paths interconnecting various components. In an embodiment, the CPU 610 may include a root complex processor.

The PCIe switch 620 may also be associated with a GPU 630 and a DPU 640, and may transmit data between at least some of the CPU 610, the GPU 630, the DPU 640, and other components. In an embodiment, the PCIe switch 620 may be associated with more than one GPU or more than one DPU. In another embodiment, the PCIe switch 620 may be located within the DPU 640. The PCIe switch 620 may manage the transfer of at least some data between the CPU 610, the GPU 630, and the DPU 640. In another embodiment, the number of GPUs associated with the PCIe switch 620 may be equal to the number of DPUs associated with the PCIe switch 620. In at least one embodiment, the server 602 may include, without limitation, any number of the CPUs 610, the PCIe switches 620, the GPUs 630, and/or the DPUs 640, in any combination. For example, in at least one embodiment, server 602 could include eight, sixteen, thirty-two, and/or more GPUs 630. In at least one embodiment, communication paths interconnecting various components, including but not limited to the CPU 610, the PCIe switch 620, the GPU 630, and the DPU 640, in FIG. 14 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 640 may include a network interface controller (NIC) 642, a DDR memory 644, and a non-volatile memory express (NVMe) device 646. The NIC 642 may be able to interface with a network 604, which may also interface with additional NVMe devices available to the DPU 640, such as over fabric. In an embodiment, the DPU 640 may not include the NVMe device 646. In another embodiment, the NVMe device 646 may be located on the server 602 and not on the DPU 640. In yet another embodiment, the computing environment 600 may include more than one of the NVMe device 646, such as a first NVMe device in the DPU 640 and a second first NVMe device on the server 602 an associated directly with the PCIe switch 620. In an embodiment, the DPU 640 may not include the DDR memory 644 and may include a computational storage services (CSS) in place of, or in addition to, the DDR memory 644. For example, computing environment 600 may include DPU computational storage (CS) memory 606 available to the DPU 640 as part of the CSS. The network 604 may be able to interface with the DPU CS memory 606 through the NIC 642, according to any suitable interface protocol, such as remote direct memory access (RDMA) over Ethernet, InfiniBand, Fiber Channel, etc.

The total memory of the computing environment 600 available for data storage may be expanded through the use of the DPU 640 on nodes of the system. The DPU 640 may have access to a pool 650 of memory already available to the server 602, such as double data rate (DDR) memory, on-board NVMe devices, NVMe devices over fabric, and CS. The pool 650 of memory may include at least one of the DDR memory 644, NVMe device 646, and the DPU CS memory 606. The DPU 640 may also be able to access the available memory of other DPUs as part of the pool 650, and other DPUs may be able to access the available memory of DPU 640, such as the pool 650. This available memory can be accessed and utilized for data storage, without the addition of compute resources, such as compute nodes, which would be required using other solutions. The available pool 650 accessible to the DPU 640 may be provisioned for the server 602 to expand the total memory available for data storage, such as to reduce the data storage load on the CPU 610 or the GPU 630, which can instead increase the utilization of their memory for processing. For example, during training of an AI, the model states, residual states, activation functions, and checkpoints can be stored, or offloaded, on the pool 650 accessible to the DPU 640.

### Multichip-Module (MCM) Assembly

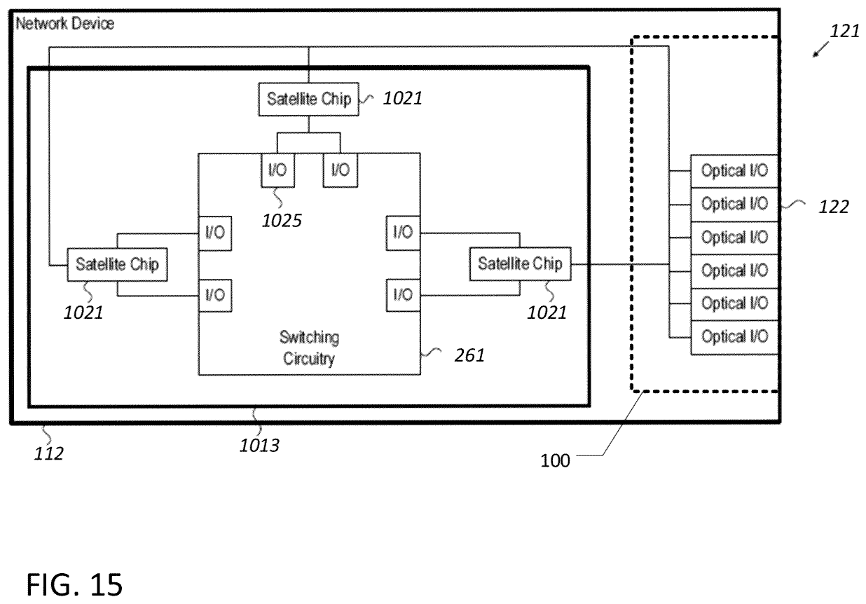

FIG. 15 is a block diagram that schematically illustrates a co-packaged Networking Device (e.g., including one or more CPO switchboards or chips) within a CPO switch tray 200 or other optical I/O switch tray, in accordance with an embodiment that is disclosed herein. In some embodiments, the different chips that constitute a co-packaged Networking Device are assembled on a single substrate in what is typically called the MCM assembly 1013, or alternatively, a plurality of substrates are provided in a co-packaged Networking Device within a CPO tray 200 that each support multiple chips thereon (e.g., collectively encompassing a plurality of MCM assemblies). The MCM assembly 1013 can include a switching circuitry embodying the computing resources 261 (embodying computing resources) surrounded by peripheral or satellite chips 1021. In some embodiments, the switching circuitry embodying the computing resources 261 and surrounding satellite chips 1021 are all mounted on a common substrate, although such a configuration is not required. The MCM assembly 1013 may be provided in a larger housing of the networking device 112, positioned behind the front panel 121. The switching circuitry embodying the computing resources 261 may include one or more core digital Application Specific Integrated Circuits (ASICs), CPUs, GPUs, microprocessors, FPGAs, combinations thereof, and the like. The switching circuitry embodying the computing resources 261 may include a number of input ports and/or output ports. The Input/Output (I/O) ports 1025 may include electrical ports and/or optical ports. Additionally, the switching circuitry embodying the computing resources 261 may include a combination of electrical blocks and optical blocks. The electrical blocks of the switching circuitry embodying the computing resources 261 may include a number of electrical switches that are configured to route signals in an electrical domain. The optical blocks of the switching circuitry embodying the computing resources 261 may include a number of optical components that are configured to generate, detect and route signals in an optical domain. The MCM assembly 1013, in some embodiments, may concern or include multiple satellite chips 1021 that are assembled on the same substrate as the switching circuitry embodying the computing resources 261. In some embodiments, a configuration of the optical block(s) and a configuration of the electrical block(s) depends (e.g., is based on) on the number of optical ports in the I/O ports 1025.

Connection points 122, which may also be referred to as optical connectors, are placed at the front panel 121. As mentioned above, connectivity between the MCM assembly 1013 and connection points 122 may be transferred to the front panel 121 through optical fibers. This connection may be made directly with an connection point 122 of the switching circuitry or may be made with one or more of the satellite chips 1021. The connection is often made with one or more of the satellite chips 1021 because the satellite chips 1021 may include the electro-optic converters and, possibly, the SERDES to natively support the connection. The satellite chips 1021 may include one or more of aDSP processor, driver, trans-impedance amplifier, laser, modulator, photodiode, serializer-deserializer, or the like.

Some embodiments of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, the term “flip chip (FC)” may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

### Packaging

In the packaging of integrated circuit (IC) chips, various packaging schemes are employed, including traditional two-dimensional (2D) integrated circuit (IC) packages as well as the more recently introduced 2.5D IC and 3D IC packages. In 2D IC packages, multiple chips are mounted on a printed circuit board, where high-performance logic, lower-performance logic, memory, and analog/RF functions, and other functional elements are presented as discrete devices in separate chip packages. By contrast, in 2.5D ICs and 3D IC packages, multiple IC chips are mounted on a silicon interposer instead of a conventional package substrate. The silicon interposer, which is typically a silicon wafer, allows very small and high-density conductive traces to be formed between the multiple IC chips because the fabrication processes used to form the conductive traces are the same processes used to form the metal interconnects in the metalization layers of a silicon chip.

Compared to 2.5D IC packages and 3D IC packages, a circuit board with individually packaged chips, such as a 2D IC package, has numerous disadvantages. For example, a 2D IC package is generally larger, heavier, consumes more power, and, because the signals propagate relatively slowly across the circuit board from one chip to another, is slower than an equivalent 2.5D or 3D IC package. Furthermore, a 2D IC package has more possible points of failure, given that the soldered joints on the circuit board are more likely to fail than the electrical connections formed within an interposer. That said, troubleshooting a 2D IC package after the different chips have been mounted on the circuit board is relatively straightforward. In particular, the conductive traces carrying I/O signals between the various chips on the circuit board are easily accessible and therefore can be employed to measure specific I/O signals during troubleshooting.

By contrast, troubleshooting a 2.5D or 3D IC package is far more problematic because the I/O signals transmitted between the different chips typically are embedded in the silicon interposer and are not physically accessible. Furthermore, because 2.5D and 3D IC packages are high-bandwidth and are quite dense, typically implementations can include thousands of conductive traces routed between the different chips. One example of such an implementation is a memory bus residing in between a processor and a high-bandwidth memory chip. In such implementations, even if the traces could be physically accessed through the silicon interposer with a probe, the accurate and reliable selection of a specific conductive trace or combination of conductive traces for the purpose of troubleshooting the IC package would be very difficult, if not impossible.

In at least one embodiment, one or more parallel processor(s) 3312 incorporate circuitry optimized for graphics and video processing, including, for example, video output circuitry, and constitutes a graphics processing unit (“GPU”). In at least one embodiment, one or more parallel processor(s) 3312 incorporate circuitry optimized for general purpose processing. In at least embodiment, components of computing system 3300 may be integrated with one or more other system elements on a single integrated circuit. For example, in at least one embodiment, one or more parallel processor(s) 3312, memory hub 3305, processor(s) 3302, and I/O hub 3307 can be integrated into a SoC integrated circuit. In at least one embodiment, components of computing system 3300 can be integrated into a single package to form a system in package (“SIP”) configuration. In at least one embodiment, at least a portion of components of computing system 3300 can be integrated into a multi-chip module (“MCM”), which can be interconnected with other multi-chip modules into a modular computing system. In at least one embodiment, I/O subsystem 3311 and display devices 3310B are omitted from computing system 3300.

In the above description, an embodiment is an example or implementation of the disclosure. The various appearances of “one embodiment,” “an embodiment,” “certain embodiments,” or “some embodiments” do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Certain embodiments of the disclosure may include features from different embodiments disclosed above, and certain embodiments may incorporate elements from other embodiments disclosed above. The disclosure of elements of the disclosure in the context of a specific embodiment is not to be taken as limiting their use in the specific embodiment alone. Furthermore, it is to be understood that the disclosure can be carried out or practiced in various ways and that the disclosure can be implemented in certain embodiments other than the ones outlined in the description above.

The disclosure is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the disclosure belongs, unless otherwise defined. While the disclosure has been described with respect to a limited number of embodiments, these should not be construed as limitations on the scope of the disclosure, but rather as exemplifications of some of the preferred embodiments. Other possible variations, modifications, and applications are also within the scope of the disclosure. Accordingly, the scope of the disclosure should not be limited by what has thus far been described, but by the appended claims and their legal equivalents.

1. An optical shuffle box comprising:
a housing having a back panel and a front panel;
a backplane array comprising m optical backplane connectors in the back panel of the housing; and
a front panel array comprising n connection points in the front panel of the housing, wherein the n connection points are optically connected with a plurality of optical backplane connectors of the m optical backplane connectors.

2. The optical shuffle box of claim 1, wherein:
the backplane array comprises a plurality of optical backplane connectors subsets;
the front panel array comprises a plurality of connection point subsets; and
each connection point subset is connected with all of the optical backplane connectors subsets.

3. The optical shuffle box of claim 2, wherein:
each of the plurality of connection point subsets define a column of connection points within the front panel of the housing;
each of the plurality of optical backplane connectors subsets are arranged in rows in the back panel of the housing.

4. The optical shuffle box of claim 1, further comprising an external laser source port array comprising a plurality of external laser source ports, wherein the plurality of external laser source ports are connected with the m connectors in the back panel.

5. The optical shuffle box of claim 1, wherein n is greater than m.

6. The optical shuffle box of claim 5, further comprising an external laser source port array comprising a plurality of external laser source ports located above the housing.

7. An optical shuffle box comprising:
a plurality of optical backplane connectors;
a front panel comprising a plurality of optical adapters;
a plurality of fibers connecting the plurality of optical backplane connectors with the plurality of optical adapters;
wherein:
the optical shuffle box is detachably connectable with one or more optical I/O computing resources in part by the plurality of optical backplane connectors to optically connect each of the plurality of optical adapters of the front panel with each of the one or more optical I/O computing resources.

8. The optical shuffle box of claim 7, wherein the plurality of optical adapters are MPO adapters.

9. The optical shuffle box of claim 7, wherein the plurality of fibers comprises one or more fiber groups, wherein each of the one or more fiber groups connect each optical adapter of the plurality of optical adapters with all of the plurality of optical backplane connectors.

10. The optical shuffle box of claim 7, wherein the optical shuffle box is one of a plurality of optical shuffle boxes each having a configuration, and wherein the optical shuffle box is detachably connectable with the one or more computing resources to enable replacement of the optical shuffle box with a second optical shuffle box of the plurality of optical shuffle boxes having a different configuration.

11. The optical shuffle box of claim 7, wherein:
the one or more optical I/O computing resources comprises a plurality of optical I/O switchboards;
the plurality of optical adapters are arranged in columns of optical adapters of the plurality of optical adapters;
each column of optical adapters is connected with each of the plurality of optical I/O switchboards through a corresponding subset of optical backplane connectors of the plurality of optical backplane connectors to provide vertical shuffling of signals from the plurality of optical I/O switchboards to the optical adapters within each column of optical adapters; and
each of the plurality of optical I/O switchboards is connected with each of the columns of optical adapters to provide horizontal shuffling of signals from the plurality of optical I/O switchboards to each column of optical adapters.

12. The optical shuffle box of claim 7, further comprising:
a plurality of cassettes occupying the front panel, wherein:
each of the plurality of cassettes is associated with a corresponding subset of optical backplane connectors of the plurality of optical backplane connectors, and
each of the plurality of cassettes comprises a corresponding subset of optical adapters of the plurality of optical adapters, wherein the corresponding subset of optical adapters is connected with the corresponding subset of optical backplane connectors.

13. The optical shuffle box of claim 12, wherein:
the one or more optical I/O computing resources comprises a plurality of optical I/O computing resources; and
the corresponding subset of optical backplane connectors associated with each of the plurality of cassettes comprises at least one optical backplane connector connected with each of the plurality of optical I/O computing resources.

14. The optical shuffle box of claim 12, wherein the plurality of optical I/O computing resources are co-packaged optics (CPO) computing resources.

15. The optical shuffle box of claim 7, further comprising a plurality of external light source connectors connected with the plurality of optical backplane connectors.

16. A method comprising:
selecting a first optical shuffle box of a plurality of optical shuffle boxes having different front panel configurations;
wherein each of the plurality of optical shuffle boxes comprise:
a plurality of optical backplane connectors;
a front panel comprising a plurality of optical adapters;
a plurality of fibers connecting the plurality of optical backplane connectors with the plurality of optical adapters; and
connecting the first optical shuffle box with one or more optical I/O computing resources at least in part by connecting the plurality of optical backplane connectors with the one or more optical I/O computing resources.

17. The method of claim 16, further comprising:
disconnecting the first optical shuffle box from the one or more optical I/O computing resources at least in part by disconnecting the plurality of optical backplane connectors from the one or more optical I/O computing resources;
selecting a second optical shuffle box from the plurality of optical shuffle boxes, wherein a front panel of the second optical shuffle box has a different configuration than the first optical shuffle box;
connecting the second optical shuffle box with the one or more optical I/O computing resources at least in part by connecting the plurality of optical backplane connectors of the second optical shuffle box with the one or more optical I/O computing resources.

18. The method of claim 16, wherein connecting the first optical shuffle box with the one or more optical I/O computing resources comprises sliding one or more alignment pins into a housing of the first optical shuffle box.

19. The method of claim 18, wherein:
the one or more alignment pins are on a tray containing the one or more optical I/O computing resources; and
sliding the one or more alignment pins into the housing of the first optical shuffle box further causes the optical backplane connectors to connect with the one or more optical I/O computing resources.
